(19) United States
(12) Patent Application Publication
(10) Pub. No.: US 2025/0259602 A1
(43) Pub. Date: Aug. 14, 2025

(54) GATE DRIVER AND DISPLAY APPARATUS INCLUDING THE SAME

(71) Applicant: LG Display Co., Ltd., Seoul (KR)

(72) Inventors: Sang Pil YOON, Paju-si (KR); Sung Hoon PAIK, Paju-si (KR)

(73) Assignee: LG Display Co., Ltd., Seoul (KR)

(21) Appl. No.: 18/984,331

(22) Filed: Dec. 17, 2024

(30) Foreign Application Priority Data
Feb. 13, 2024 (KR) 10-2024-0020502

(51) Int. Cl. G09G 3/3266; G09G 3/20; G09G 3/3233

(52) U.S. Cl. CPC G09G 3/3266; G09G 3/2096; G09G 3/3233; G09G 2300/0408; G09G 2310/0286; G09G 2320/0233; G09G 2320/0673

(57) ABSTRACT

A gate driver and a display apparatus including the same are discussed. The gate driver can include a plurality of stages. An n^{th} stage among the plurality of stages includes a pull-up transistor configured to control a flow of a current between an output node and an input terminal for an n^{th} clock based on a voltage of a Q node, a pull-down transistor configured to control a flow of a current between the output node and an input terminal of a first low power source based on a voltage of a QB node, and a QB node controller configured to control the voltage of the QB node based on a voltage of a control power source and the voltage of the Q node, where n is an integer.

### CROSS-REFERENCE TO RELATED APPLICATIONS

This application claims priority to Korean Patent Application No. 10-2024-0020502, filed in the Republic of Korea on Feb. 13, 2024, the entirety of which is hereby expressly incorporated by reference into the present application.

### BACKGROUND

### Technical Field

The present disclosure relates to a gate driver and a display apparatus including the same.

### Discussion of the Related Art

Display apparatuses include a plurality of pixels arranged as a matrix type and supply pixels with image data synchronized with a scan signal and thus, adjust the luminance of the pixels. The display apparatuses generate the scan signal by using a gate driver including a plurality of gate stages. Each of the gate stages of the gate driver is connected to a gate line of the display panel. Each gate stage includes a plurality of transistors and outputs the scan signal, swinging between a scan on voltage and a scan off voltage, to the gate line of the display panel.

Since the number of gate lines increases as a resolution increases in a display screen having a certain size, the number of gate stages can increase in a high-resolution display apparatus. When the number of gate stages increases, however, an area of a bezel area including the gate stages can inevitably increase. As such, there can be a limitation in reducing a bezel in the display apparatuses.

### SUMMARY OF THE DISCLOSURE

To overcome the aforementioned problem and other limitations of the related art, the present disclosure can provide a gate driver and a display apparatus including the same, in which configurations of gate stages can be simplified and thus, a narrow bezel can be implemented.

To achieve these objects and other advantages and in accordance with the purpose of the disclosure, as embodied and broadly described herein, a gate driver includes a plurality of stages. An n^{th} stage of the plurality of stages includes a pull-up transistor configured to control a flow of a current between an output node and an input terminal for an n^{th} clock, based on a voltage of a Q node, a pull-down transistor configured to control a flow of a current between the output node and an input terminal of a first low power source, based on a voltage of a QB node, and a QB node controller configured to control the voltage of the QB node, based on a voltage of a control power source and the voltage of the Q node, wherein the voltage of the control power source has an on level in a vertical active period of one frame and has an off level in a vertical blank period of the one frame, where n is an integer. For example, n can be an integer greater than 4.

In another aspect of the present disclosure, a display apparatus is provided which comprises a display panel including a plurality of gate lines; and a gate driver including a plurality of stages connected to the plurality of gate lines, wherein an n^{th} stage of the plurality of stages comprises: a pull-up transistor configured to control a flow of a current between an output node and an input terminal for an n^{th} clock, based on a voltage of a Q node; a pull-down transistor configured to control a flow of a current between the output node and an input terminal of a first low power source, based on a voltage of a QB node; and a QB node controller configured to control the voltage of the QB node, based on a voltage of a control power source and the voltage of the Q node, wherein the voltage of the control power source has an on level in a vertical active period of one frame and has an off level in a vertical blank period of the one frame, where n is an integer. For example, n can be an integer greater than 4.

### BRIEF DESCRIPTION OF THE DRAWINGS

The accompanying drawings, which are included to provide a further understanding of the disclosure and are incorporated in and constitute a part of this application, illustrate embodiment(s) of the disclosure and together with the description serve to explain the principle of the disclosure. In the drawings:

FIG. 1 is a diagram illustrating a display apparatus according to one or more embodiments of the present disclosure;

FIG. 2 is a diagram schematically illustrating an equivalent circuit of a pixel provided in a display panel of FIG. 1;

FIG. 3 is a diagram illustrating gate stages connected to gate lines according to an example of the present disclosure;

FIG. 4 is a diagram illustrating an n^{th} gate stage connected to an n^{th} gate line according to aspects of the present disclosure;

FIG. 5 is a diagram illustrating driving signals for driving the n^{th} gate stage according to aspects of the present disclosure;

FIGS. 6 and 7 are diagrams illustrating an operation of the n^{th} gate stage during a first period according to aspects of the present disclosure;

FIGS. 8 and 9 are diagrams illustrating an operation of the n^{th} gate stage during a second period according to aspects of the present disclosure;

FIGS. 10 and 11 are diagrams illustrating an operation of the n^{th} gate stage during a third period according to aspects of the present disclosure;

FIGS. 12 and 13 are diagrams illustrating an operation of the n^{th} gate stage during a fourth period according to aspects of the present disclosure; and

FIGS. 14 and 15 are diagrams illustrating an operation of the n^{th} gate stage during a fifth period according to aspects of the present disclosure.

### DETAILED DESCRIPTION OF THE EMBODIMENTS

Hereinafter, the present disclosure will be described more fully with reference to the accompanying drawings, in which exemplary embodiments of the disclosure are shown. The disclosure may, however, be embodied in many different forms and should not be construed as being limited to the embodiments set forth herein; rather, these embodiments are provided so that this disclosure will be thorough and complete, and will fully convey the concept of the disclosure to those skilled in the art.

Advantages and features of the present disclosure, and implementation methods thereof will be clarified through following embodiments described with reference to the accompanying drawings. The present disclosure may, however, be embodied in different forms and should not be construed as limited to the embodiments set forth herein. Rather, these embodiments are provided so that this disclosure will be thorough and complete, and will fully convey the scope of the present disclosure to those skilled in the art.

The shapes, sizes, ratios, angles, numbers and the like disclosed in the drawings for description of various embodiments of the present disclosure to describe embodiments of the present disclosure are merely exemplary and the present disclosure is not limited thereto. Like reference numerals refer to like elements throughout. Throughout this specification, the same elements are denoted by the same reference numerals. As used herein, the terms “comprise”, “having,” “including” and the like suggest that other parts can be added unless the term “only” is used. As used herein, the singular forms “a”, “an”, and “the” are intended to include the plural forms as well, unless context clearly indicates otherwise.

Elements in various embodiments of the present disclosure are to be interpreted as including margins of error even without explicit statements. Further, the term “can” fully encompasses all the meanings and coverages of the term “may.”

In describing a position relationship, for example, when a position relation between two parts is described as “on”, “over”, “under”, and “next”, one or more other parts can be disposed between the two parts unless “just” or “direct” is used.

It will be understood that, although the terms “first”, “second”, etc. can be used herein to describe various elements, these elements should not be limited by these terms. These terms are only used to distinguish one element from another and may not define order or sequence. For example, a first element could be termed a second element, and, similarly, a second element could be termed a first element, without departing from the scope of the present disclosure.

In the present disclosure, a pixel circuit and a gate driver provided on a substrate of a display panel can be implemented with a transistor having an N metal oxide semiconductor field effect transistor (MOSFET) type, but are not limited thereto. A transistor can be a three-electrode element which includes a gate, a source, and a drain. The source can be an electrode which supplies a carrier to a transistor. In the transistor, a carrier can start to flow from the source. The drain can be an electrode which enables the carrier to flow out from the transistor. That is, in a MOSFET, the carrier flows from the source to the drain. In N MOS, because a carrier is a hole, a source voltage can be higher than a drain voltage so that the hole flows from the source to the drain. In N MOS, because the hole flows from the drain to the source, a current can flow from the drain to the source. It should be noted that a source and a drain of a MOSFET are not fixed. For example, the source and the drain of the MOSFET can switch therebetween. Therefore, in describing an embodiment of the present disclosure, one of a source and a drain can be described as a first electrode, and the other of the source and the drain can be described as a second electrode.

Hereinafter, embodiments of the present disclosure will be described in detail with reference to the accompanying drawings. All the components of each device/apparatus according to all embodiments of the present disclosure are operatively coupled and configured. In the following description, in an electroluminescent display apparatus, an organic light emitting display apparatus including an organic light emitting material will be mainly described. However, it should be noted that the inventive concept is not limited to the organic light emitting display apparatus and can be applied to an inorganic light emitting display apparatus including an inorganic light emitting material.

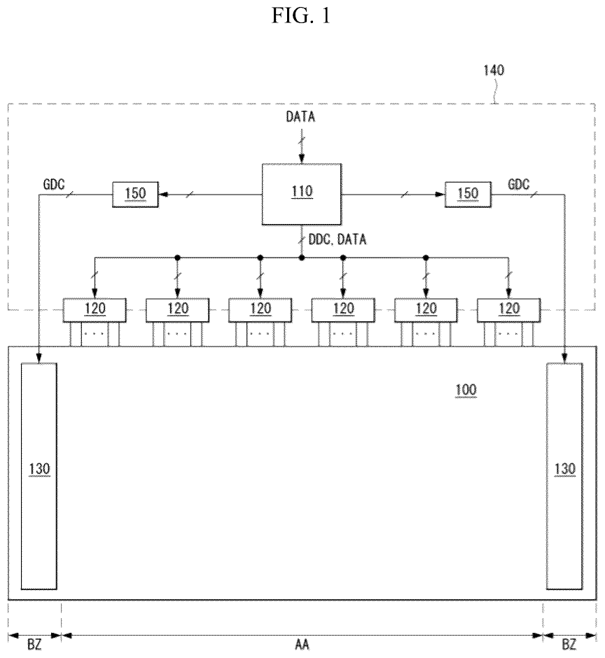

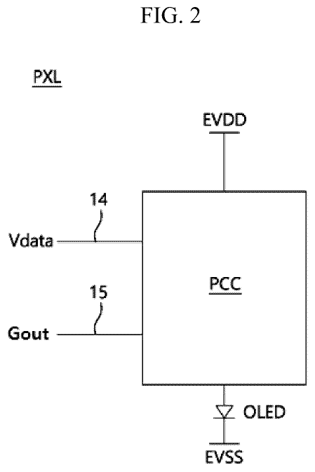

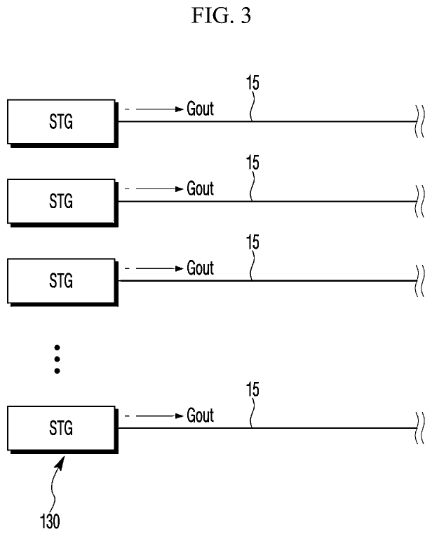

FIG. 1 is a diagram illustrating a display apparatus according to one or more embodiments of the present disclosure. FIG. 2 is a diagram schematically illustrating an equivalent circuit of a pixel provided in a display panel of FIG. 1. FIG. 3 is a diagram illustrating gate stages connected to gate lines according to an example of the present disclosure.

Referring to FIG. 1, the display apparatus according to the present embodiment can include a display panel 100, a timing controller 110, a data driver 120, a gate driver 130, and a level shifter 150. The display apparatus according to the present embodiment can be implemented as an electroluminescence display apparatus, but is not limited thereto.

In the display panel 100, as in FIG. 2, pixels PXL connected to a data line 14 and a gate line 15 can be arranged as a matrix type to configure a pixel array. A plurality of horizontal pixel lines can be included in the pixel array, and a plurality of pixels PXL which are horizontally adjacent to one another and are connected to the gate line 15 in common can be arranged in each horizontal pixel line. Here, a horizontal pixel line can denote a set of pixels of one horizontal line implemented by pixels PXL horizontally adjacent to one another, instead of a physical signal line. The pixel array can include a power line which transfers a high-level pixel source voltage EVDD to the pixels PXL. Also, the pixels PXL can be further connected to a low-level pixel source voltage EVSS.

Each of the pixels PXL, as shown in FIG. 2, can include a light emitting device OLED and a pixel driving circuit PCC for driving the light emitting device OLED. The pixel driving circuit PCC can include a driving element which generates a driving current which is to be applied to the light emitting device OLED and a switch circuit connected to the driving element. The switch circuit can set and maintain a gate-source voltage of the driving element. To this end, the switch circuit can be supplied with a data voltage Vdata through the data line 14, supplied with a gate signal Gout through the gate line 15, and supplied with the high-level pixel source voltage EVDD through a power line, thereby setting the gate-source voltage of the driving element. A gate electrode of a switch element included in the switch circuit can be connected to the gate line 15, and a first electrode (or a second electrode) of the switch element included in the switch circuit can be connected to a data line.

Each of the pixels PXL can be one of a red pixel, a green pixel, a blue pixel, and a white pixel. The red pixel, the green pixel, the blue pixel, and the white pixel can configure one unit pixel and can implement various colors. A color implemented in a unit pixel can be determined based on an emission rate of each of the red pixel, the green pixel, the blue pixel, and the white pixel. Furthermore, the white pixel can be omitted, and in this case, the unit pixel can be configured with the red pixel, the green pixel, and the blue pixel. Also, the number of gate lines 15 connected to the pixel PXL can be singular or plural.

Referring to FIG. 1, the data driver 120 can receive image data DATA and a source timing control signal DDC from the timing controller 110. In response to the source timing control signal DDC from the timing controller 110, the data driver 120 can convert the image data DATA into a gamma compensation voltage to generate a data voltage Vdata and can supply the data voltage Vdata to the data lines 14 of the display panel 100, based on a supply timing of the gate signal Gout. The data driver 120 can be connected to the data lines 14 of the display panel 100 through a chip on glass (COG) process or a tape automated bonding (TAB) process. The data driver 120 can be divisionally disposed in plurality, but is not limited thereto and can be provided as one data driver.

Referring to FIG. 1, the level shifter 150 can generate a gate timing control signal GDC for driving a switch element of a pixel, based on an on/off control clock which has a transistor-transistor-logic (TTL) level and is input from the timing controller 110. The gate timing control signal GDC can include a start signal and a clock signal, which swing between an on level and an off level. The level shifter 150 can supply the gate timing control signal GDC to the gate driver 130.

Referring to FIGS. 1 to 3, the gate driver 130 can operate based on the gate timing control signal GDC input from the level shifter 150 to generate the gate signal Gout needed for driving of the pixel PXL. Also, the gate driver 130 can supply the gate signal Gout to the gate lines 15.

The gate driver 130 can be directly provided on a lower substrate of the display panel 100 by using a gate driver in panel (GIP) type. The gate driver 130 can be provided in a non-display area (i.e., a bezel area BZ) outside a screen in the display panel 100. The non-display area or the bezel area BZ can be disposed adjacent to a display area or active area AA. The bezel area BZ can surround the display area AA entirely or only in part(s). In the GIP type, the level shifter 150 can be mounted on a printed circuit board (PCB) 140 along with the timing controller 110.

The gate driver 130 can include a plurality of gate stages STG which are connected to one another, based on a cascading scheme. Each of the plurality of gate stages STG can be connected to a corresponding gate line 15 and can output the gate signal Gout to the corresponding gate line 15.

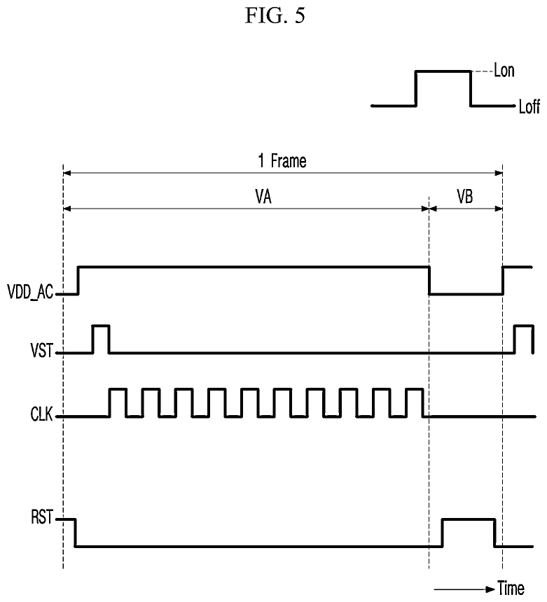

Some gate stages of the plurality of gate stages STG can start to operate based on a start signal (VST of FIG. 5). Also, each of the other gate stages except the some gate stages can start to operate based on an output (i.e., a previous carry signal) of a previous gate stage which has operated prior thereto.

The gate driver 130 can be disposed in both bezel areas BZ facing the display panel 100 and can supply the scan signal to each gate line, based on a double feeding scheme, thereby minimizing signal distortion caused by a load deviation of each gate line.

Referring to FIG. 1, the timing controller 110 can be connected to an external host system by various interface types known to those skilled in the art. The timing controller 110 can receive video data DATA from the host system, correct the video data DATA to compensate for a luminance deviation caused by an electrical characteristic difference, and transfer the corrected video data to the data driver 120.

The timing controller 110 can receive a timing signal such as a vertical synchronization signal Vsync, a horizontal synchronization signal Hsync, a data enable signal DE, and a main clock MCLK from the host system and can generate an on/off control clock based on the source timing control signal DDC and the gate timing control signal GDC, based on the timing signal.

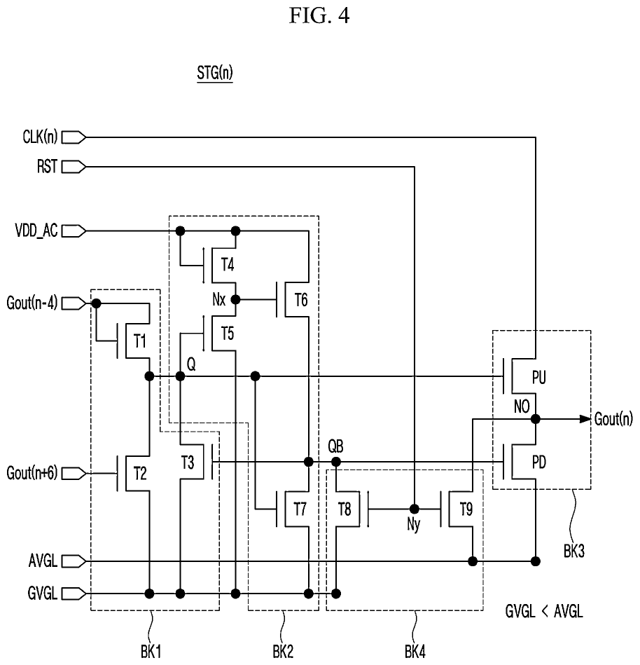

FIG. 4 is a diagram illustrating an n^{th} gate stage STG(n) connected to an n^{th} gate line according to aspects of the present disclosure, and FIG. 5 is a diagram illustrating driving signals for driving the n^{th} gate stage STG(n) according to aspects of the present disclosure.

Referring to FIGS. 4 and 5, in the n^{th} gate stage STG(n), a voltage of a control power source VDD applied to a second block BK2 can use an alternating current (AC) voltage instead of a direct current (DC) voltage, so as to reduce the number of transistors included in the second block BK2, where n is an integer.

In a related art, additional transistors which are driven based on a VDD_DC voltage and an AC control signal to precharge a QB node are needed for controlling the QB node.

In contrast, an AC-type control power source VDD according to the present embodiment can replace the VDD_DC voltage and the AC control signal. According to the present embodiment, the additional transistors of the related art used to precharge the QB node can be omitted. In the present embodiment, the AC-type control power source VDD having an on level can be applied to the QB node through transistors T4 and T6.

A voltage of the AC-type control power source VDD (VDD_AC) according to the present embodiment can be input at an on level Lon in a vertical active period VA of one frame and can be input at an off level Loff in a vertical blank period VB of the one frame.

A configuration of the n^{th} gate stage STG(n) according to an example of the present disclosure will be described below in detail.

The n^{th} gate stage STG(n) can include a first block BK1, the second block BK2, a third block BK3, and a fourth block BK4.

The first block BK1 can be a Q node controller for controlling a voltage of a Q node. The Q node controller can be configured to control the voltage of the Q node, based on a carry signal and the voltage of the QB node. The first block BK1 can include a transistor T1 which is connected to the Q node and an input terminal for a previous carry signal Gout(n−4) input from an (n−4)^{th} stage, a transistor T2 which connects the Q node to an input terminal of a second low power source GVGL according to a next carry signal Gout(n+6) input from an (n+6)^{th} stage, and a transistor T3 which connects the Q node to the input terminal of the second low power source GVGL according to a next carry signal Gout(n+6) input from an (n+6)^{th} stage. The previous carry signal can be for charging the Q node with an on voltage, and the next carry signal can be for discharging the Q node to an off voltage. In the present embodiment, an output of the (n−4)^{th} stage can be provided as the previous carry signal, and an output of the (n+6)^{th} stage can be provided as the next carry signal, but the inventive concept is not limited thereto. However, when the output of the (n+6)^{th} stage instead of the output of the (n−4)^{th} stage is applied as the next carry signal, a Q node charge maintenance time can increase, and thus, the stability of an operation can be secured.

A gate electrode and a drain electrode of the transistor T1 can be connected to the input terminal for the previous carry signal Gout(n−4), and a source electrode of the transistor T1 can be connected to the Q node. A gate electrode of the transistor T2 can be connected to an input terminal for the next carry signal Gout(n+6), a drain electrode of the transistor T2 can be connected to the Q node, and a source electrode of the transistor T2 can be connected to the input terminal of the second low power source GVGL. A gate electrode of the transistor T3 can be connected to the QB node, a drain electrode of the transistor T3 can be connected to the Q node, and a source electrode of the transistor T3 can be connected to the input terminal of the second low power source GVGL.

The second block BK2 can be a QB node controller for controlling the voltage of the QB node. The second block BK2 can include a transistor T4 which is connected to a first control node Nx and the input terminal of the control power source VDD, a transistor T5 which connects the first control node Nx to the input terminal of the second low power source GVGL with the voltage of the Q node, a transistor T6 which applies the voltage of the control power source VDD to the QB node with a voltage of the first control node Nx, and a transistor T7 which connects the QB node to the input terminal of the second low power source GVGL with the voltage of the Q node.

A gate electrode and a drain electrode of the transistor T4 can be connected to the input terminal of the control power source VDD, and a source electrode of the transistor T4 can be connected to the first control node Nx. A gate electrode of the transistor T5 can be connected to the Q node, a drain electrode of the transistor T5 can be connected to the first control node Nx, and a source electrode of the transistor T5 can be connected to the input terminal of the second low power source GVGL. A gate electrode of the transistor T6 can be connected to the first control node Nx, a drain electrode of the transistor T6 can be connected to the input terminal of the control power source VDD, and a source electrode of the transistor T6 can be connected to the QB node. A gate electrode of the transistor T7 can be connected to the Q node, a drain electrode of the transistor T7 can be connected to the QB node, and a source electrode of the transistor T7 can be connected to the input terminal of the second low power source GVGL.

The third block BK3 can be an output unit for outputting the gate signal Gout(n). The third block BK3 can include a pull-up transistor PU which controls a flow of a current between an input terminal for an n^{th} clock CLK(n) and an output node NO, based on the voltage of the Q node, and a pull-down transistor PD which controls a flow of a current between an input terminal of a first low power source AVGL and the output node NO, based on the voltage of the QB node.

A gate electrode of the pull-up transistor PU can be connected to the Q node, a drain electrode of the pull-up transistor PU can be connected to the input terminal for the n^{th} clock CLK(n), and a source electrode of the pull-up transistor PU can be connected to the output node NO. A gate electrode of the pull-down transistor PD can be connected to the QB node, a drain electrode of the pull-down transistor PD can be connected to the output node NO, and a source electrode of the pull-down transistor PD can be connected to the input terminal of the first low power source AVGL.

The fourth block BK4 can be a reset unit which resets a voltage of the output node NO to a voltage of the first low power source AVGL and resets the voltage of the QB node to the voltage of the second low power source GVGL, during the vertical blank period VB.

The fourth block BK4 can include a transistor T8 which connects the QB node to the input terminal of the second low power source GVGL, based on a reset signal RST, and a transistor T9 which connects the output node NO to the input terminal of the first low power source AVGL, based on the reset signal RST.

A gate electrode of the transistor T8 can be connected to a second control node Ny, a drain electrode of the transistor T8 can be connected to the QB node, and a source electrode of the transistor T8 can be connected to the input terminal of the second low power source GVGL. A gate electrode of the transistor T9 can be connected to the second control node Ny, a drain electrode of the transistor T9 can be connected to the output node NO, and a source electrode of the transistor T9 can be connected to the input terminal of the first low power source AVGL.

A time for which the QB node is maintained at an on voltage level is longer than that for which the Q node is maintained at an on voltage level, and due to this, the pull-down transistor PD can be easily degraded. The fourth block BK4 can reset the voltage of the QB node to the voltage of the second low power source GVGL in the vertical blank period VB, based on the reset signal RST, thereby decreasing a degradation in the pull-down transistor PD.

To this end, the reset signal RST can be input at an on level Lon for a partial time of the vertical blank period VB and can be input at an off level Loff in the vertical active period VA and the other time of the vertical blank period VB.

When the pull-down transistor PD is degraded, an off current can flow through the pull-down transistor PD having an off state. Such an off current can distort a waveform of the gate signal Gout(n). To prevent an off current of the pull-down transistor PD, the voltage of the first low power source AVGL can be set to be greater than the voltage of the second low power source GVGL. In a state where the pull-down transistor PD is turned off, the second low power source GVGL can be connected to the gate electrode of the pull-down transistor PD, and the first low power source AVGL can be connected to the source electrode of the pull-down transistor PD. At this time, when the voltage of the first low power source AVGL is greater than the voltage of the second low power source GVGL, an off current may not flow in the pull-down transistor PD, based on a reverse bias applied between the gate electrode and the source electrode of the pull-down transistor PD.

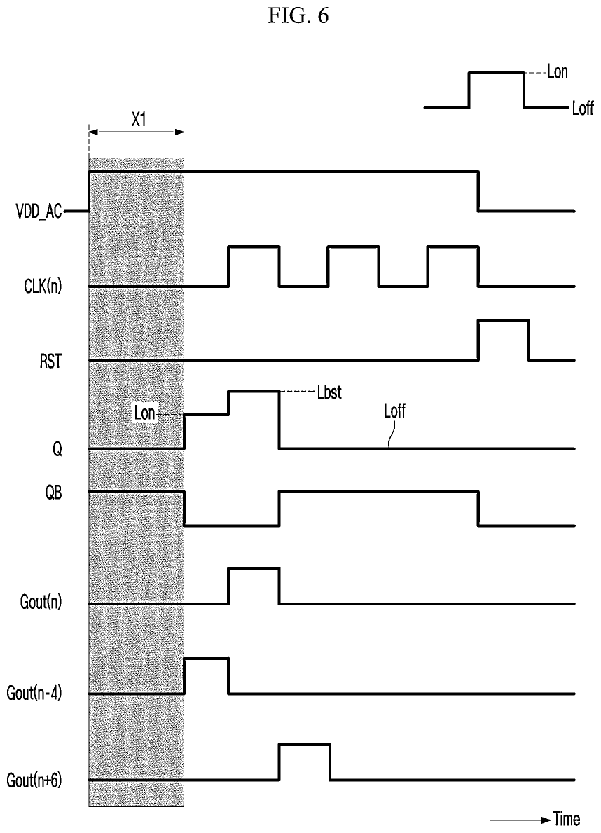

An operation of the n^{th} gate stage STG(n) can be divided into first to fifth periods (X1 to X5 of FIGS. 6 to 15). Here, the first to fourth periods (X1 to X4 of FIGS. 6 to 15) can correspond to the vertical active period VA, and the fifth period (X5 of FIGS. 6 to 15) can correspond to the vertical blank period VB.

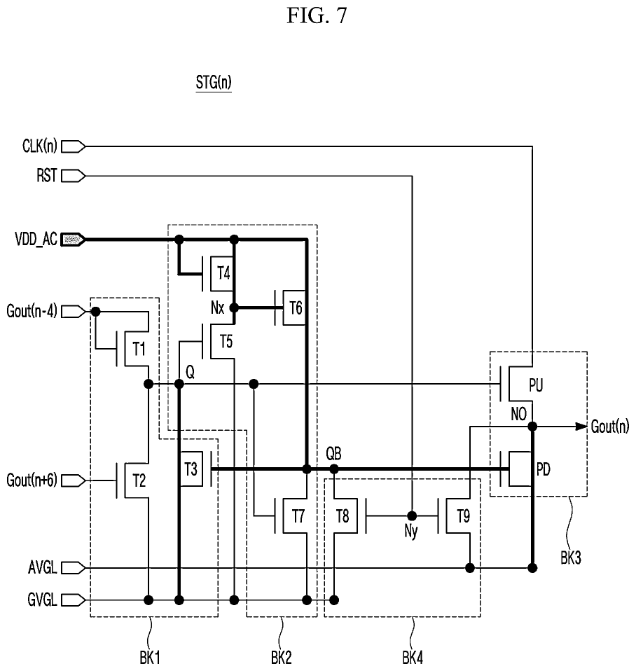

FIGS. 6 and 7 are diagrams illustrating an operation of the n^{th} gate stage STG(n) during a first period X1 according to aspects of the present disclosure.

Referring to FIGS. 6 and 7, during the first period X1, the voltage of the control power source VDD can be input at the on level Lon, and thus, the transistor T4 and the transistor T6 can be turned on. Based on the voltage of the control power source VDD having the on level Lon, the voltage of the QB node can have the on level Lon. Based on the voltage of the QB node having the on level Lon, the transistor T3 and the pull-down transistor PD can be turned on. Based on the second low power source GVGL connected through the transistor T3, the voltage of the Q node can have the off level Loff. Based on the first low power source AVGL connected through the pull-down transistor PD, the voltage of the output node NO can have the off level Loff.

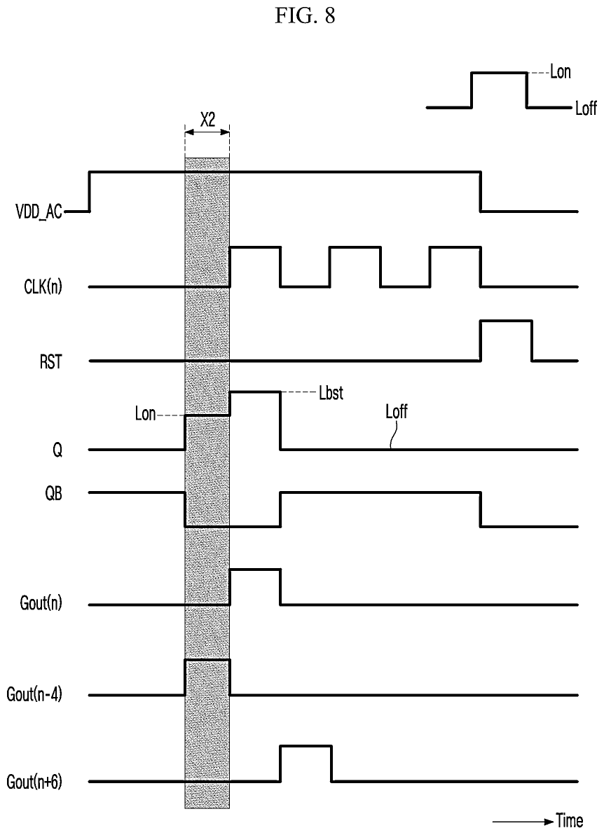

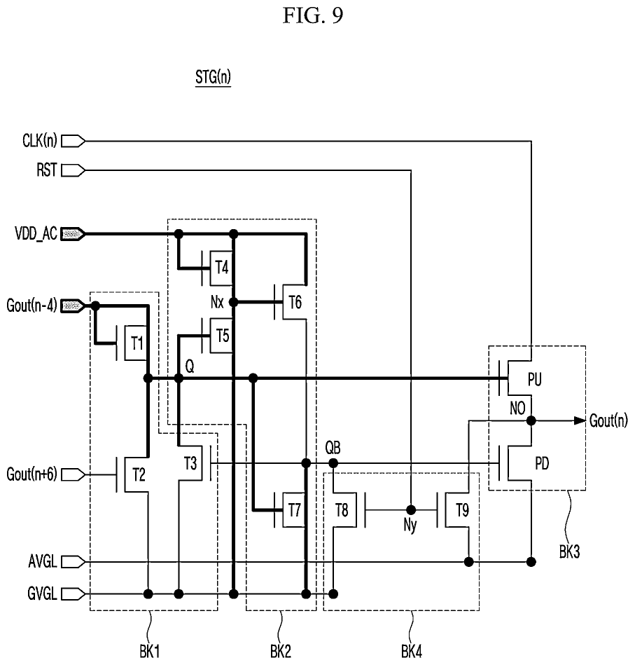

FIGS. 8 and 9 are diagrams illustrating an operation of the n^{th} gate stage STG(n) during a second period X2 according to aspects of the present disclosure.

Referring to FIGS. 8 and 9, during the second period X2, the transistor T1 can be turned on by the previous carry signal Gout(n−4) having the on level Lon, and the Q node can be charged at the on level Lon. Based on the voltage of the Q node having the on level Lon, the transistor T5, the transistor T7, and the pull-up transistor PU can be turned on. As the transistor T5 is turned on, the second low power source GVGL can be connected to the first control node Nx, and thus, the transistor T6 can be turned off. Even when the voltage of the control power source VDD having the on level Lon is applied to the first control node Nx through the transistor T4 during the second period X2, the voltage of the control power source VDD having the on level Lon can be discharged to the voltage of the second low power source GVGL through the transistor T5. As the transistor T7 is turned on, the voltage of the QB node can have the off level Loff. As the pull-up transistor PU is turned on, the clock signal CLK(n) having the off level Loff can be output to the output node NO.

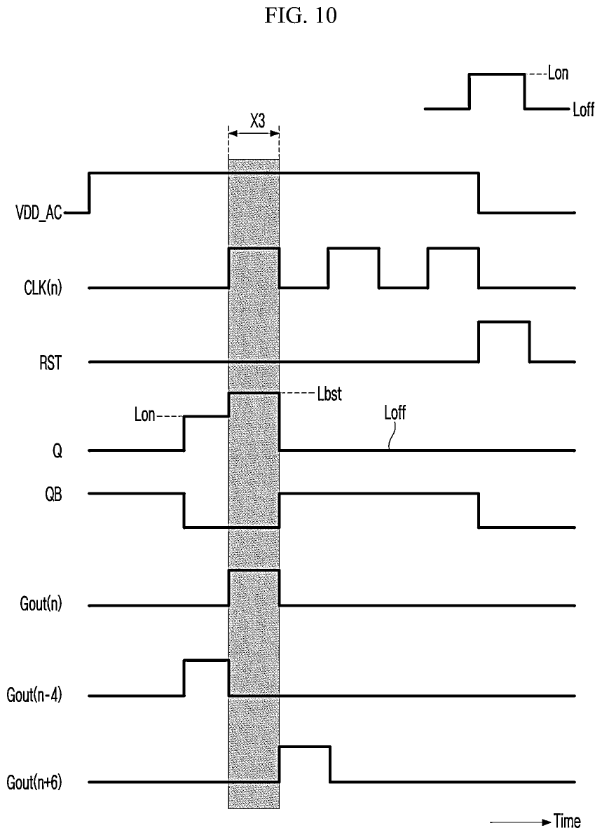

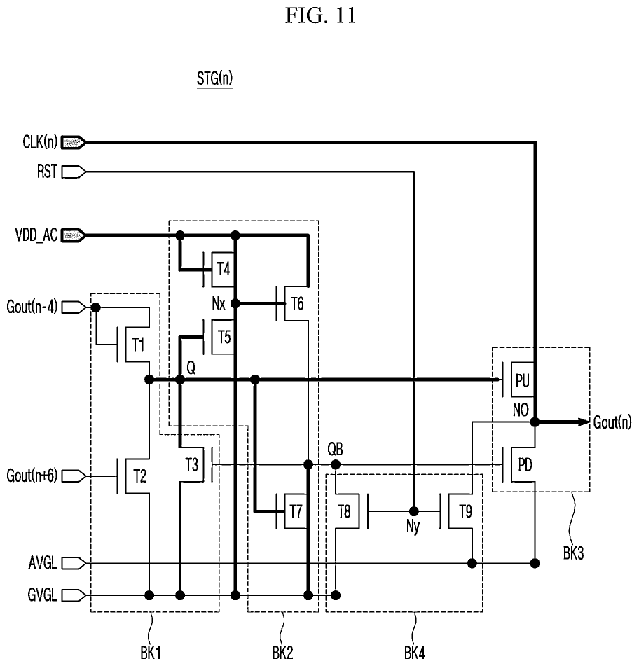

FIGS. 10 and 11 are diagrams illustrating an operation of the n^{th} gate stage STG(n) during a third period X3 according to aspects of the present disclosure.

Referring to FIGS. 10 and 11, when the clock signal CLK(n) having the on level Lon is input during the third period X3, the voltage of the Q node can be up-shifted from the on level Lon to a bootstrapping level Lbst, based on coupling of a parasitic capacitor connected between the gate electrode and the drain electrode of the pull-up transistor PU. The bootstrapping level Lbst can be a voltage which is higher than the on level Lon. When the voltage of the Q node is up-shifted to the bootstrapping level Lbst, an on-response characteristic of the pull-up transistor PU can be quickened. When the voltage of the Q node is up-shifted to the bootstrapping level Lbst, a gate-source voltage of the pull-up transistor PU can increase, and thus, the amount of current flowing in the pull-up transistor PU can increase. At this time, the clock signal CLK(n) having the on level Lon can be output to the output node NO, based on the turn-on of the pull-up transistor PU, and thus, can be the gate signal Gout(n) having the on level Lon.

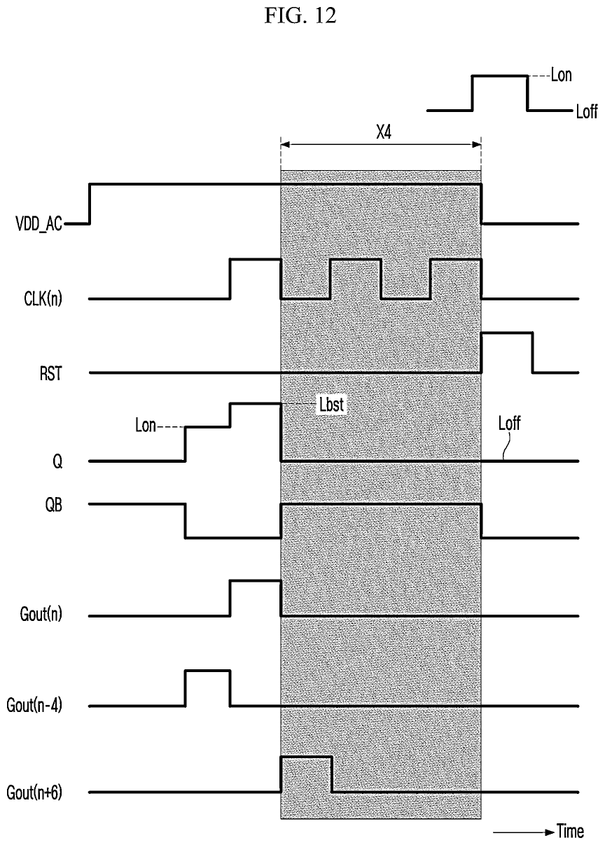

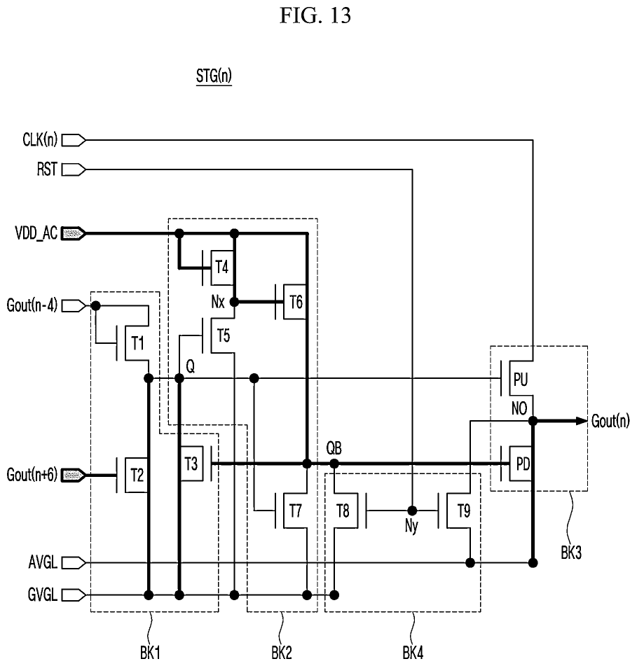

FIGS. 12 and 13 are diagrams illustrating an operation of the n^{th} gate stage STG(n) during a fourth period X4 according to aspects of the present disclosure.

Referring to FIGS. 12 and 13, during the fourth period X4, the transistor T2 can be turned on by the next carry signal Gout(n+6) having the on level Lon, and the Q node can be discharged to the off level Loff. Based on the voltage of the Q node having the off level Loff, the transistor T5, the transistor T7, and the pull-up transistor PU can be turned off. As the transistor T5 is turned off, the transistor T6 can be turned on, and thus, the voltage of the QB node can have the on level Lon. Based on the voltage of the QB node having the on level Lon, the transistor T3 and the pull-down transistor PD can be turned on. Based on the second low power source GVGL connected through the transistor T3, the voltage of the Q node can maintain the off level Loff while the transistor T3 is being turned on. Based on the first low power source AVGL connected through the pull-down transistor PD, the voltage of the output node NO can have the off level Loff.

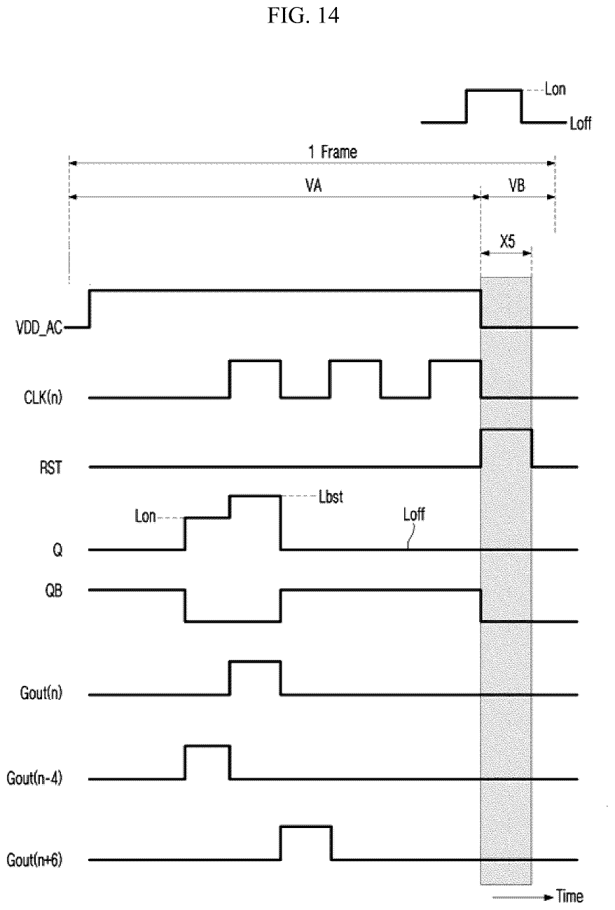

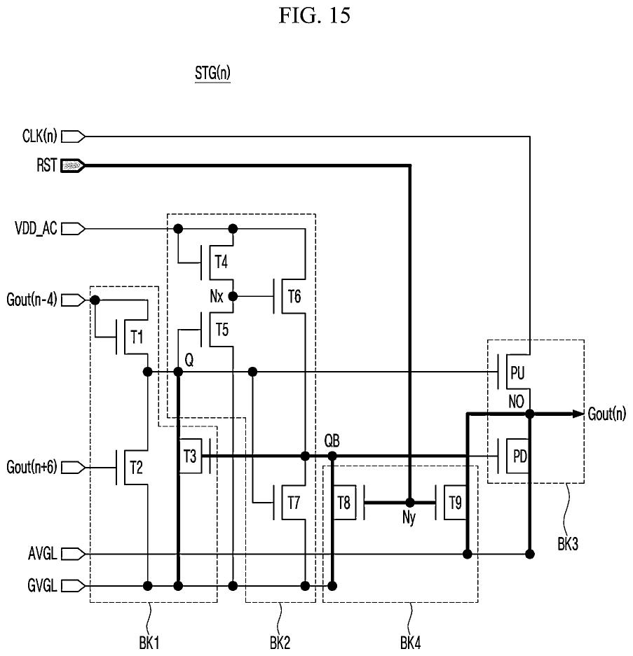

FIGS. 14 and 15 are diagrams illustrating an operation of the n^{th} gate stage STG(n) during a fifth period X5 according to aspects of the present disclosure.

Referring to FIGS. 14 and 15, during the fifth period X5, the voltage of the control power source VDD can be input at the off level Loff, and the reset signal RST can be input at the on level Lon. The transistor T8 and the transistor T9 can be turned on by the reset signal RST having the on level Lon. As a result, the voltage of the QB node can be reset to the voltage of the second low power source GVGL, and the output node NO can be reset to the first low power source AVGL, thereby preventing an operation (i.e., the waveform distortion of the gate signal Gout(n)) of an abnormal operation caused by coupling of an external source voltage during the vertical blank period VB. When the voltage of the QB node is reset to the voltage of the second low power source GVGL at every vertical blank period VB, a degradation in the transistors T3 and PD including the gate electrodes connected to the QB node can be reduced.

In the gate driver and the display apparatus including the same according to the embodiments of the present disclosure, configurations of gate stages can be simplified, and thus, a narrow bezel can be implemented

The effects according to the present disclosure are not limited to the above examples, and other various effects can be included in the specification.

While the present disclosure has been particularly shown and described with reference to exemplary embodiments thereof, it will be understood by those of ordinary skill in the art that various changes in form and details can be made therein without departing from the spirit and scope of the present disclosure as defined by the following claims.

What is claimed is:

1. A gate driver comprising:
a plurality of stages including an n^{th} stage, where n is an integer,
wherein the n^{th} stage comprises:
a pull-up transistor configured to control a flow of a current between an output node and an input terminal for an n^{th} clock, based on a voltage of a Q node;
a pull-down transistor configured to control a flow of a current between the output node and an input terminal of a first low power source, based on a voltage of a QB node; and
a QB node controller configured to control the voltage of the QB node, based on a voltage of a control power source and the voltage of the Q node, and
wherein the voltage of the control power source has an on level in a vertical active period of one frame and has an off level in a vertical blank period of the one frame.

2. The gate driver of claim 1, wherein the QB node controller comprises:
a fourth transistor connected to an input terminal of the control power source and a first control node;
a fifth transistor configured to connect the first control node to an input terminal of a second low power source, based on the voltage of the Q node;
a sixth transistor configured to apply the voltage of the control power source to the QB node, based on the voltage of the first control node; and
a seventh transistor configured to connect the QB node to the input terminal of the second low power source, based on the voltage of the Q node.

3. The gate driver of claim 2, wherein a voltage of the first low power source is greater than a voltage of the second low power source.

4. The gate driver of claim 1, further comprising a Q node controller configured to control the voltage of the Q node, based on a carry signal and the voltage of the QB node.

5. The gate driver of claim 4, wherein the Q node controller comprises:
a first transistor connected to the Q node and an input terminal for a previous carry signal input from an (n−4)^{th} stage;
a second transistor configured to connect the Q node to an input terminal of a second low power source, based on a next carry signal input from an (n+6)^{th} stage; and
a third transistor configured to connect the Q node to the input terminal of the second low power source, based on the voltage of the QB node.

6. The gate driver of claim 5, wherein a voltage of the first low power source is greater than a voltage of the second low power source.

7. The gate driver of claim 1, further comprising:
an eighth transistor configured to connect the QB node to an input terminal of a second low power source, based on a reset signal; and
a ninth transistor configured to connect the output node to the input terminal of the first low power source, based on the reset signal.

8. The gate driver of claim 7, wherein the reset signal is input at an on level for a partial time of the vertical blank period of the one frame, and is input at an off level in the vertical active period and the other time of the vertical blank period of the one frame.

9. The gate driver of claim 7, wherein a voltage of the first low power source is greater than a voltage of the second low power source.

10. A display apparatus comprising:
a display panel including a plurality of gate lines; and
a gate driver including a plurality of stages connected to the plurality of gate lines,
wherein an n^{th} stage of the plurality of stages comprises:
a pull-up transistor configured to control a flow of a current between an output node and an input terminal for an n^{th} clock, based on a voltage of a Q node;
a pull-down transistor configured to control a flow of a current between the output node and an input terminal of a first low power source, based on a voltage of a QB node; and
a QB node controller configured to control the voltage of the QB node, based on a voltage of a control power source and the voltage of the Q node,
wherein the voltage of the control power source has an on level in a vertical active period of one frame and has an off level in a vertical blank period of the one frame, where n is an integer.

11. The display apparatus of claim 10, further comprising a Q node controller configured to control the voltage of the Q node, based on a carry signal and the voltage of the QB node.
